(19) United States
(12) Patent Application Publication
(10) Pub. No.: US 2020/0361242 A1
(43) Pub. Date: Nov. 19, 2020

(54) Pneumatic Tire Having a Lightweight Crown Reinforcement

(71) Applicant: COMPAGNIE GENERALE DES ETABLISSEMENTS MICHELIN, Clermont-Ferrand (FR)

(72) Inventors: Nathslie SALGUES, Clermont-Ferrand Cedex 9 (FR); Aurore LARDJANE, Clermont-Ferrand Cedex 9 (FR); Agnès DEGEORGES, Clermont-Ferrand Cedex 9 (FR)

(21) Appl. No.: 16/762,215

(22) PCT Filed: Nov. 7, 2018
(86) PCT No.: PCT/FR2018/052750

§ 371 Date: May 7, 2020

(30) Foreign Application Priority Data
Nov. 8, 2017 (FR) 17/60482

(51) Int. Cl. B60C 9/20; B60C 1/00

(52) U.S. Cl. CPC B60C 9/2006; B60C 1/00; B60C 2200/06; B60C 2009/2064; B60C 2009/2077; B60C 2001/0066

(57) ABSTRACT

The invention relates to a tire (1) comprising a crown reinforcement formed of two working crown layers (41, 43), the calendering layers of which comprise carbon black, and of a layer of circumferential reinforcing elements (42).

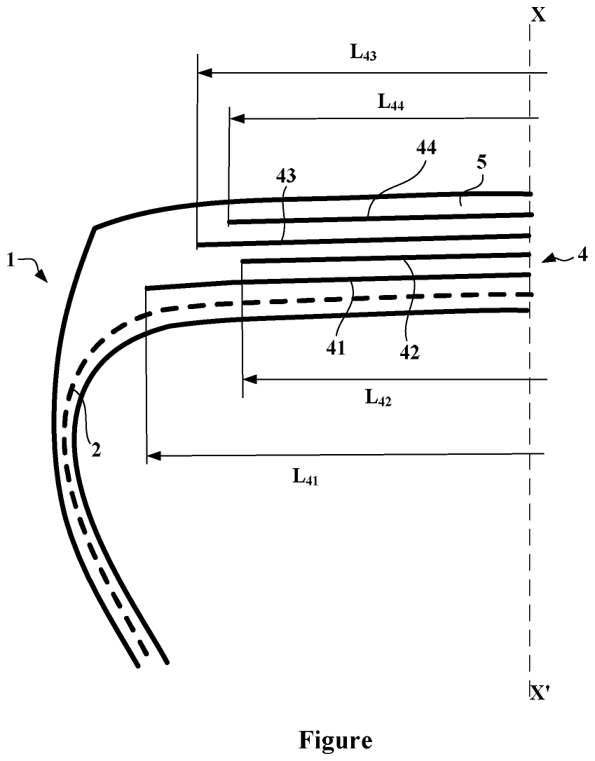

According to the invention, the reinforcing elements of the working crown layers (41, 43) are metal cords having a diameter of less than 1.3 mm, at least one thread of each metal cord of at least one working crown layer is of at least UHT grade, the tensile elastic modulus at 10% elongation of at least the radially outermost calendering layer of at least the radially outermost working crown layer (43) is less than 8.5 MPa and at least said radially outermost calendering layer of at least the radially outermost working crown layer (43) has a macrodispersion Z value of greater than 85.

The present invention relates to a tire having a radial carcass reinforcement, and more particularly a tire intended for fitting to vehicles that carry heavy loads, such as lorries, tractors, trailers or buses, for example.

In tires of heavy-duty type, the carcass reinforcement is generally anchored on either side in the region of the bead and is surmounted radially by a crown reinforcement composed of at least two layers that are superposed and formed of threads or cords which are parallel in each layer and crossed from one layer to the next, forming angles of between 10° and 45° with the circumferential direction. Said working layers that form the working reinforcement may furthermore be covered with at least one layer, referred to as protective layer, formed of reinforcing elements which are advantageously metal and extensible and are referred to as elastic reinforcing elements. It may also comprise a layer of metal threads or cords forming an angle of between 45° and 90° with the circumferential direction, this ply, referred to as the triangulation ply, being located radially between the carcass reinforcement and the first crown ply, referred to as the working ply, which is formed of parallel threads or cords lying at angles not exceeding 45° in terms of absolute value. The triangulation ply forms a triangulated reinforcement with at least said working ply, this reinforcement having little deformation under the various stresses to which it is subjected, the triangulation ply essentially serving to absorb the transverse compressive forces to which all the reinforcing elements in the crown region of the tire are subjected.

Cords are said to be inextensible when said cords exhibit, under a tensile force equal to 10% of the breaking force, a relative elongation at most equal to 0.2%.

Cords are said to be elastic when said cords exhibit, under a tensile force equal to the breaking load, a relative elongation at least equal to 3% with a maximum tangent modulus of less than 150 GPa.

Circumferential reinforcing elements are reinforcing elements which form angles with the circumferential direction in the range +2.5°, −2.5° around 0°.

The circumferential direction of the tire, or longitudinal direction, is the direction that corresponds to the periphery of the tire and is defined by the direction in which the tire runs.

The transverse or axial direction of the tire is parallel to the axis of rotation of the tire.

The radial direction is a direction that intersects the axis of rotation of the tire and is perpendicular thereto.

The axis of rotation of the tire is the axis about which it turns in normal use.

A radial or meridian plane is a plane which contains the axis of rotation of the tire.

The circumferential median plane, or equatorial plane, is a plane which is perpendicular to the axis of rotation of the tire and divides the tire into two halves.

For metal threads or cords, force at break (maximum load in N), breaking strength (in MPa), elongation at break (total elongation in %) and modulus (in GPa) are measured under tension in accordance with standard ISO 6892, 1984.

Certain present-day tires, referred to as “road tires”, are intended to run at high average speeds and over increasingly long journeys, because of improvements to the road network and the growth of motorway networks worldwide. The combined conditions under which such a tire is called upon to run undoubtedly make it possible to increase the distance covered, since tire wear is lower. This increase in life in terms of distance covered, combined with the fact that such conditions of use are likely, under heavy load, to result in relatively high crown temperatures, dictates the need for an at least proportional increase in the durability of the crown reinforcement of the tires.

This is because there are stresses in the crown reinforcement and, more particularly, shear stresses between the crown layers which, in the case of an excessive rise in the operating temperature at the ends of the axially shortest crown layer, result in the appearance and propagation of cracks in the rubber at said ends. The same problem exists in the case of edges of two layers of reinforcing elements, said other layer not necessarily being radially adjacent to the first layer.

In order to improve the endurance of the crown reinforcement of the tires, French application FR 2 728 510 proposes arranging, on the one hand, between the carcass reinforcement and the crown reinforcement working ply that is radially closest to the axis of rotation, an axially continuous ply which is formed of inextensible metal cords that form an angle at least equal to 60° with the circumferential direction and of which the axial width is at least equal to the axial width of the shortest working crown ply and, on the other hand, between the two working crown plies, an additional ply formed of metal elements that are oriented substantially parallel to the circumferential direction.

In addition, French application WO 99/24269 notably proposes, on each side of the equatorial plane and in the immediate axial continuation of the additional ply of reinforcing elements substantially parallel to the circumferential direction, that the two working crown plies formed of reinforcing elements crossed from one ply to the next be coupled over a certain axial distance and then uncoupled using profiled elements of rubber compound over at least the remainder of the width that said two working plies have in common.

Moreover, the use of tires on heavy duty vehicles of the “worksite supply” type means that the tires are subjected to shock loadings when running over stony ground. These shock loadings are of course detrimental with regard to performance in terms of endurance.

It is also known practice for a person skilled in the art to increase the number of plies of which the crown reinforcement is made in order to improve the endurance of the tire with respect to such shock loadings.

In all of the solutions presented above, the presence of one or more layers of additional reinforcing elements leads to a greater mass of the tire and to higher tire manufacturing costs.

The working crown plies may thus be lightened for example by increasing the spacing at which the cords are distributed or alternatively by using reinforcing elements of smaller diameter and smaller cross section as described for example in document U.S. Pat. No. 3,240,249. It should be noted that this reduction in diameter and cross section of the reinforcing elements is very often accompanied by an increase in the toughness of the steel which limits or compensates for the penalty in terms of breaking force.

It is thus known to use smaller reinforcing elements in order to lighten the tires, the mass being on the one hand reduced by a smaller amount of metal and on the other hand by the volume of elastomer compounds which decrease in order to form the calenderings of the layers of reinforcing elements.

Nonetheless, the decrease in the amount of metal does not go in the direction of improved performance in terms of endurance.

Especially when an isolated obstacle of a relatively large size is accidentally driven over, all of the plies are suddenly subjected to extensive deformation which may go so far as to completely break the crown block. This type of damage of an accidental origin is conventionally qualified as “road hazard”.

It has been found that the ability of a tire comprising working crown plies that have been lightened to withstand road hazards may prove to be very significantly reduced. The additional forces caused by the very large deformation are taken on by the working crown plies which, because they have been lightened, prove to be highly sensitized to the risk of breakage. This sensitivity to breakage is also increased when the reinforcing elements are subjected to oxidation phenomena.

It is therefore an aim of the invention to provide tires for “heavy duty” vehicles with reduced mass while retaining satisfactory performance in terms of endurance and ability to withstand road hazards.

This aim is achieved according to the invention by a tire for a vehicle of heavy duty type, having a radial carcass reinforcement comprising a crown reinforcement formed of at least two working crown layers, each comprising metal reinforcing elements inserted between two calendering layers of elastomer compound comprising a reinforcing filler consisting of at least carbon black, the crown reinforcement being capped radially by a tread, said tread being connected to two beads via two sidewalls, the crown reinforcement comprising at least one layer of circumferential reinforcing elements, the reinforcing elements of the working crown layers being metal cords having a diameter of less than 1.3 mm, at least one thread of each metal cord of at least one working crown layer being of at least UHT grade, the tensile elastic modulus at 10% elongation of at least the radially outermost calendering layer of at least the radially outermost working crown layer being less than 8.5 MPa, and at least said radially outermost calendering layer of at least the radially outermost working crown layer having a macrodispersion Z value of greater than 85.

For the purposes of the invention, the diameter of a reinforcing element is the diameter of the circle circumscribed on the cross section of the reinforcing element, measured in a section of the tire perpendicular to the average direction of the reinforcing element.

For the purposes of the invention, a “thread of at least UHT grade” is a thread exhibiting a mechanical breaking strength R expressed in MPa such that R≥4180−2130×D, D being the diameter of the thread expressed in mm.

A macrodispersion Z value of greater than 85 for a filled elastomer compound means that the filler is dispersed through the elastomer matrix of the composition with a dispersion Z value of greater than or equal to 85.

In the present description, the dispersion of filler in an elastomer matrix is characterized by the Z value which is measured, after crosslinking, according to the method described by S. Otto et al. in Kautschuk Gummi Kunststoffe, 58 Jahrgang, NR 7-8/2005, in accordance with standard ISO 11345.

The calculation of the Z value is based on the percentage of surface area in which the filler is not dispersed (“% undispersed surface area”), as measured by the “disperGRADER+” device supplied, with its operating procedure and its “disperDATA” operating software, by Dynisco, according to the equation:

Z=100−(% undispersed surface area)/0.35.

The undispersed surface area percentage is, for its part, measured using a camera looking at the surface of the sample under incident light at 30°. The light points are associated with filler and agglomerates, whereas the dark points are associated with the rubber matrix; digital processing converts the image into a black and white image, and allows the percentage of undispersed surface area to be determined as described by S. Otto in the above-mentioned document.

The higher the Z value, the better the dispersion of the filler in the rubber matrix (a Z value of 100 corresponding to perfect dispersion and a Z value of 0 corresponding to mediocre dispersion). A Z value of greater than or equal to 80 will be deemed to correspond to a surface area having very good dispersion of the filler in the elastomer matrix.

The elastomer compounds constituting at least said radially outermost calendering layer of at least one protective layer are prepared according to known methods.

In order to achieve a macrodispersion Z value of greater than 85, the elastomer compound may advantageously be prepared by creating a masterbatch of diene elastomer and of reinforcing filler.

For the purposes of the invention, a “masterbatch” is understood to mean elastomer-based composite into which a filler has been introduced.

There are various ways of obtaining a masterbatch of diene elastomer and of reinforcing filler. In particular, one type of solution involves, in order to improve the dispersion of the filler in the elastomer matrix, mixing the elastomer and the filler in the “liquid” phase. To do this, use is made of an elastomer in the form of latex, which is in the form of elastomer particles dispersed in water, and of an aqueous dispersion of the filler, i.e. a filler dispersed in water, commonly referred to as a “slurry”.

Thus, according to one of the variants of the invention, the masterbatch is obtained by liquid-phase mixing starting from a diene elastomer latex containing natural rubber and an aqueous dispersion of a filler containing carbon black.

More preferentially still, the masterbatch according to the invention is obtained according to the following process steps that make it possible to obtain a very good dispersion of the filler in the elastomer matrix:
feeding a first continuous stream of a diene elastomer latex to a mixing zone of a coagulation reactor that defines an elongated coagulation zone extending between the mixing zone and an outlet,
feeding said mixing zone of the coagulation reactor with a second continuous stream of a fluid comprising a filler under pressure in order to form a mixture with the elastomer latex by mixing the first fluid and the second fluid in the mixing zone sufficiently energetically to coagulate the elastomer latex with the filler prior to the outlet, said mixture flowing as a continuous stream towards the outlet zone and said filler being capable of coagulating the elastomer latex,
recovering the coagulum obtained previously at the outlet of the reactor in the form of a continuous stream and drying it in order to recover the masterbatch.

Such a method of preparing a masterbatch in the liquid phase is described for example in document WO 97/36724.

Advantageously according to the invention, the elastomer—filler bonding of the first layer S of polymer compound is characterized by a “bound rubber” content, measured prior to crosslinking, of greater than 35%.

The test referred to as the “bound rubber” test makes it possible to determine the proportion of elastomer, in a non-vulcanized composition, which is associated with the reinforcing filler so intimately that this proportion of elastomer is insoluble in the standard organic solvents. Knowing this insoluble proportion of rubber, which is fixed by the reinforcing filler during the mixing, gives a quantitative indication of the reinforcing activity of the filler in the rubber composition. Such a method has been described, for example, in standard NF T 45-114 (June 1989) as applied to determining the content of elastomer bound to the carbon black.

This test, which is well known to a person skilled in the art for characterizing the quality of reinforcement afforded by the reinforcing filler, has, for example, been described in the following documents: Plastics, Rubber and Composites Processing and Applications, Vol. 25, No 7, p. 327 (1996); Rubber Chemistry and Technology, Vol. 69, p. 325 (1996).

In this instance, the content of elastomer that cannot be extracted with toluene is measured after a sample of rubber composition (typically 300-350 mg) has been left for 15 days to swell in this solvent (for example in 80-100 cm³ of toluene), followed by a step of drying for 24 hours at 100° C., under vacuum, before weighing the sample of rubber composition thus treated. The swelling step described hereinabove is preferably carried out at ambient temperature (approximately 20° C.) and away from light, and the solvent (toluene) is changed once, for example after the first five days of swelling. The “bound rubber” content (wt %) is calculated in the known way as the difference between the initial weight and the final weight of the sample of rubber composition, after the fraction of components that are insoluble by nature, other than the elastomer, initially present in the rubber composition have been accounted for and eliminated in the calculation.

According to a preferred embodiment of the invention, the reinforcing elements of at least one working layer are cords comprising an internal layer of M internal thread(s) and an external layer of N external threads, the external layer being wound around the internal layer.

Preferably, according to this advantageous variant of the invention, M=1 or 2 and N=5, 6, 7, 8 or 9, preferably M=1 and N=5 or 6, or M=2 and N=7, 8 or 9.

In other words, advantageously according to this preferred embodiment of the invention, at least one of the internal or external threads, and more preferably each internal and external thread, of each cord of at least one working layer exhibits a mechanical breaking strength R expressed in MPa such that R≥4180−2130×D, D being the diameter of the thread expressed in mm.

Further preferably according to the invention, at least one of the internal or external threads, preferably each internal and external thread, of each cord of at least one working layer exhibits a mechanical breaking strength R expressed in MPa such that R≥4400−2000×D, D being the diameter of the thread expressed in mm.

Further preferably according to the invention, the reinforcing elements of the working crown layers are cords comprising an internal layer of M internal thread(s) and an external layer of N external threads, the external layer being wound around the internal layer, with M=1 or 2 and N=5, 6, 7 or 8, at least one of the internal or external threads of each cord, and preferably each internal and external thread of each cord, exhibiting a mechanical breaking strength R expressed in MPa such that R≥4180−2130×D, D being the diameter of the thread expressed in mm.

And even more preferentially according to the invention, the reinforcing elements of said at least two working layers are cords comprising an internal layer of M internal thread(s) and an external layer of N external threads, the external layer being wound around the internal layer, with M=1 or 2 and N=5, 6, 7 or 8, at least one of the internal or external threads of each cord, and preferably each internal and external thread of each cord, exhibiting a mechanical breaking strength R expressed in MPa such that R≥4400−2000×D, D being the diameter of the thread expressed in mm.

The results obtained with tires in accordance with the invention have indeed demonstrated that performance in terms of endurance may be retained especially when running on stony ground, with the crown reinforcement of the tire being lightened.

Against all expectations, the results have indeed demonstrated that the tires according to the invention may be lightened by decreasing especially the metal mass of the working crown layers while retaining the endurance properties of the crown of the tire especially in terms of shock loadings appearing on the tread for example when running over stony ground.

The tests performed showed that the use of the elastomer compounds according to the invention comprising a reinforcing filler formed of at least carbon black, having a tensile elastic modulus at 10% elongation of less than 8.5 MPa and a macrodispersion Z value of greater than 85, in order to produce at least the radially outermost calendering layer of at least the radially outermost working crown layer makes it possible to improve the properties of the tire in terms of endurance.

The inventors believe they have especially demonstrated that the choice of compounds according to the invention in order to produce at least said radially outermost calendering layer of at least the radially outermost working crown layer which lead especially to a calendering layer which is weakly conductive, compared with more conventional compounds, limits the phenomena of corrosion of the reinforcing elements of the radially outermost working crown layer.

Moreover, the tensile elastic moduli at 10% elongation of the calenderings of the working crown layers in accordance with the invention appear to be favorable to performance in terms of endurance when running over stony ground. Usually, the tensile elastic moduli at 10% elongation of the calenderings of the working crown layers are greater than 8.5 MPa and mostly greater than 10 MPa. Such elastic moduli are especially required in order to make it possible to limit the extent to which the reinforcing elements of the working crown layers are placed under compression, especially when the vehicle is following a winding route, when maneuverings in car parks or else when negotiating roundabouts. This is because the shearing actions along the axial direction which act on the tread in the region of the contact surface with the ground result in the reinforcing elements of a working crown layer being placed under compression.

The inventors have been able to demonstrate that the layer of circumferential reinforcing elements makes it possible to choose lower elastic moduli for the rubber compounds of the calendering layers of the working crown layers, without adversely affecting the endurance properties of the tire owing to the reinforcing elements of said working crown layers being placed under compression as described above.

The inventors have also been able to demonstrate that the cohesion of the calendering layers of the working crown layers, when they have a tensile elastic modulus at 10% elongation of less than 8.5 MPa, remains satisfactory.

For the purposes of the invention, a cohesive rubber compound is a rubber compound that is especially robust in relation to cracking. The cohesion of a compound is thus evaluated by a fatigue cracking test performed on a “PS” (pure shear) test specimen. It consists in determining, after notching the test specimen, the crack propagation rate “Vp” (nm/cycle) as a function of the energy release rate “E” (J/m²). The experimental range covered by the measurement is within the range −20° C. and +150° C. in temperature, with an atmosphere of air or of nitrogen. The stressing of the test specimen is an imposed dynamic movement with an amplitude of between 0.1 mm and 10 mm in the form of an impulsive type stress loading (“haversine” tangent signal) with a rest time equal to the duration of the impulse; the frequency of the signal is of the order of 10 Hz on average.

The measurement comprises 3 parts:
An accommodation of the “PS” test specimen, of 1000 cycles at 27% deformation.
Energy characterization in order to determine the “E”=f (deformation) law. The energy release rate “E” is equal to WO*h0, with W0=energy supplied to the material per cycle and per unit volume and h0=initial height of the test specimen. Exploitation of the “force/displacement” acquisitions thus gives the relationship between “E” and the amplitude of the stress loading.
Measuring the cracking, after the notching of the “PS” test specimen. The data collected results in the determination of the crack propagation rate “Vp” as a function of the imposed stress loading level “E”.

The inventors have especially demonstrated that the presence of at least one layer of circumferential reinforcing elements helps to reduce the change in cohesion of the calendering layers of the working crown layers. Specifically, the more conventional tire designs, especially comprising calendering layers of the working crown layers with tensile elastic moduli at 10% elongation of greater than 8.5 MPa, lead to a change in the cohesion of said calendering layers of the working crown layers, this cohesion tending to become weaker. The inventors observe that the presence of at least one layer of circumferential reinforcing elements which helps to limit the compression of the reinforcing elements of the working crown layers, especially when the vehicle is following a winding route, and also limits the temperature increases, results in a small change in the cohesion of the calendering layers. The inventors consider, therefore, that the cohesion of the calendering layers of the working crown layers, which is lower than that found in the more commonly used tire designs, is satisfactory in the tire design according to the invention.

Advantageously according to the invention, all of the calendering layers of the working crown layers have a tensile elastic modulus at 10% elongation of less than 8.5 MPa and a macrodispersion Z value of greater than 85.

According to a preferred embodiment of the invention, at least said radially outermost calendering layer of at least the radially outermost working crown layer has an electrical resistivity per unit volume ρ such that log(ρ) is greater than 8.

The electrical resistivity per unit volume ρ is measured statically in accordance with standard ASTM D 257, ρ being expressed in ohm·cm.

More preferably, all of the calendering layers of the working crown layers have an electrical resistivity per unit volume ρ such that log(ρ) is greater than 8.

According to a preferred embodiment of the invention, the maximum value of tan(δ), denoted tan(δ)max, of at least the radially outermost calendering layer of at least the radially outermost working crown layer is less than 0.080 and preferably less than 0.070.

Preferably, all of the calendering layers of the working crown layers have a maximum value of tan(δ), denoted tan(δ)max, of less than 0.080 and preferably less than 0.070.

The loss factor tan(δ) is a dynamic property of the layer of rubber compound. It is measured on a viscosity analyzer (Metravib VA4000) according to standard ASTM D 5992-96. The response of a sample of vulcanized composition (cylindrical test specimen with a thickness of 2 mm and with a cross section of 78 mm²), subjected to a simple alternating sinusoidal shear stress, at a frequency of 10 Hz, at a temperature of 100° C., is recorded. A strain amplitude sweep is carried out from 0.1% to 50% (forward cycle) and then from 50% to 1% (return cycle). The results made use of are the complex dynamic shear modulus (G*) and the loss factor tan(δ) measured on the return cycle. For the return cycle, the maximum observed tan(δ) value is indicated, denoted tan(δ)ₘₐₓ.

Rolling resistance is the resistance that occurs when the tire is rolling. It is represented by the hysteresis losses associated with the deformation of the tire during a revolution. The frequency values associated with the revolution of the tire correspond to tan(δ) values measured between 30 and 100° C. The value for tan(δ) at 100° C. thus corresponds to an indicator of the rolling resistance of the tire when rolling.

The inventors were further able to demonstrate that the choice of compounds according to this preferred embodiment of the invention in order to produce at least the radially outermost calendering layer of at least the radially outermost working crown layer makes it possible to improve the properties of the tire in terms of rolling resistance, due to the relatively low maximum value of tan(δ), denoted tan(δ)max.

According to a preferred embodiment of the invention, at least the radially outermost calendering layer of at least the radially outermost working crown layer is an elastomer compound based on natural rubber or on synthetic polyisoprene with a predominance of cis-1,4-linkages and optionally on at least one other diene elastomer, the natural rubber or synthetic polyisoprene in the case of a blend being present at a predominant content relative to the content of the other diene elastomer(s) used and on a reinforcing filler consisting:
a) either of carbon black used at a content of between 20 and 80 phr,
b) or of a blend of carbon black and a white filler, in which the overall filler content is between 20 and 80 phr, and preferably between 40 and 60 phr, said white filler being of silica and/or alumina type, comprising SiOH and/or AlOH surface functions selected from the group consisting of precipitated or fumed silicas, the aluminas or aluminosilicates, or else carbon blacks modified during or after synthesis, with a BET specific surface area of between 30 and 260 m²/g.

The BET specific surface area measurement is performed in accordance with the Brunauer, Emmet and Teller method described in “The Journal of the American Chemical Society”, vol. 60, page 309, February 1938, corresponding to standard NFT 45007 of November 1987.

If a clear filler or a white filler is being used, it is necessary to use a coupling agent and/or a covering agent selected from the agents known to a person skilled in the art. Mention may be made, as examples of preferential coupling agents, of alkoxysilane sulfides of the bis(3-trialkoxysilylpropyl) polysulfide type, and among these especially of bis(3-triethoxysilylpropyl) tetrasulfide, sold by Degussa under the name Si69 for the pure liquid product and the name X50S for the solid product (50/50 by weight blend with N330 black). Mention may be made, as examples of covering agents, of a fatty alcohol, an alkylalkoxysilane such as a hexadecyltrimethoxysilane or hexadecyltriethoxysilane respectively sold by Degussa under the names Si116 and Si216, diphenylguanidine, a polyethylene glycol or a silicone oil, optionally modified by means of OH or alkoxy functions. The covering and/or coupling agent is used in a weight ratio relative to the filler of ≥1/100 and ≤20/100, and preferentially of between 2/100 and 15/100 when the clear filler represents the whole of the reinforcing filler and of between 1/100 and 20/100 when the reinforcing filler is composed of a blend of carbon black and clear filler.

Other examples of reinforcing fillers that have the morphology and surface SiOH and/or AlOH functions of materials of the silica and/or alumina type described hereinabove and that can be used according to the invention as a partial or complete replacement for these include carbon blacks modified either during synthesis by addition, to the oil fed to the oven, of a silicon and/or aluminium compound, or after synthesis by addition, to an aqueous suspension of carbon black in a solution of sodium silicate and/or aluminate, of an acid so as to at least partially cover the surface of the carbon black with SiOH and/or AlOH functions. As nonlimiting examples of carbon-based fillers of this type with SiOH and/or AlOH functions at the surface, mention may be made of the fillers of CSDP type described in Conference No. 24 of the ACS Meeting, Rubber Division, Anaheim, Calif., 6-9 May 1997, and also those of patent application EP-A-0 799 854. As other nonlimiting examples, mention may be made of the fillers sold by Cabot Corporation under the name Ecoblack™ “CRX 2000” or “CRX4000”, or else the fillers described in the publications US2003040553, WO9813428; such a reinforcing filler preferentially contains a silica content of 10% by weight of the reinforcing filler.

Included among the diene elastomers that can be used as a blend with the natural rubber or a synthetic polyisoprene with a predominance of cis-1,4-linkages, mention may be made of a polybutadiene (BR), preferably with a predominance of cis-1,4-linkages, a solution or emulsion stirene-butadiene copolymer (SBR), a butadiene-isoprene copolymer (BIR) or, alternatively still, a stirene-butadiene-isoprene terpolymer (SBIR). These elastomers can be elastomers modified during polymerization or after polymerization by means of branching agents, such as a divinylbenzene, or star-branching agents, such as carbonates, halotins or halosilicons, or alternatively still by means of functionalization agents resulting in grafting, to the chain or at the chain end, of oxygen-based carbonyl or carboxyl functions or else of an amine function, such as, for example, by the action of dimethylaminobenzophenone or diethylaminobenzophenone. In the case of blends of natural rubber or synthetic polyisoprene with a predominance of cis-1,4-linkages with one or more of the diene elastomers mentioned above, the natural rubber or the synthetic polyisoprene is preferably used at a predominant content and more preferentially at a content of greater than 70 phr.

Advantageously, according to a variant embodiment of the invention, the metal reinforcing elements of at least the radially outermost working crown layer are cords having a flow rate of less than 5 cm³/min in the “permeability” test.

The test referred to as the permeability test makes it possible to determine the longitudinal permeability to air of the cords tested, by measuring the volume of air passing along a test specimen under constant pressure over a given period of time. The principle of such a test, which is well known to a person skilled in the art, is to demonstrate the effectiveness of the treatment of a cord to make it impermeable to air; it has been described for example in standard ASTM D2692-98.

The test is carried out on cords extracted directly, by stripping, from the vulcanized rubber plies which they reinforce, thus penetrated by the cured rubber.

The test is carried out on a 2 cm length of cord, which is therefore coated with its surrounding rubber compound (or coating rubber) in the cured state, in the following way: air is injected into the inlet end of the cord at a pressure of 1 bar and the volume of air at the outlet end is measured using a flow meter (calibrated for example from 0 to 500 cm³/min). During the measurement, the sample of cord is immobilized in a compressed airtight seal (for example, a seal made of dense foam or of rubber) so that only the amount of air passing along the cord from one end to the other, along its longitudinal axis, is taken into account by the measurement; the airtightness of the airtight seal itself is checked beforehand using a solid rubber test specimen, that is to say one devoid of cord.

The lower the mean air flow rate measured (mean over 10 test specimens), the higher the longitudinal impermeability of the cord. As the measurement is carried out with an accuracy of ±0.2 cm³/min, measured values of less than or equal to 0.2 cm³/min are regarded as zero; they correspond to a cord which can be described as airtight (completely airtight) along its axis (i.e. in its longitudinal direction).

This permeability test also constitutes a simple means of indirect measurement of the degree of penetration of the cord by a rubber composition. The lower the flow rate measured, the greater the degree of penetration of the cord by the rubber.

Cords having a flow rate of less than 20 cm³/min in the “permeability” test have a degree of penetration of greater than 66%.

Cords having a flow rate of less than 2 cm³/min in the “permeability” test have a degree of penetration of greater than 90%.

Advantageously, according to this variant of the invention, the value, in the “permeability” test, of the metal reinforcing elements of at least the radially outermost working crown layer may be obtained with compounds of the calendering layers having a fluidity greater than those of the more customary compounds.

Such values in the “permeability” test appear to further improve the endurance of the tires, especially during particularly severe attacks on the tires leading to oxidizing agents accessing the reinforcing elements of at least the radially outermost working crown layer. Indeed, greater penetration of the metal reinforcing elements of at least the radially outermost working crown layer by the calendering compounds is beneficial to lessening the propagation of the oxidizing agents within the reinforcing elements. In the case of attacks that may make it possible for the oxidizing agents to access the reinforcing elements, such a penetration of the reinforcing elements limits direct contact between the oxidizing agents and the metal reinforcing elements. The oxidation of the reinforcing elements thus continues to occur essentially due to the oxidizing agents passing as far as the calendering layer, the intensity of the oxidation being decreased by the choice of the compounds constituting at least the radially outer calendering of at least the radially outermost working crown layer, which compounds have weak electric conductivity.

According to one preferred embodiment of the invention, said at least one layer of circumferential reinforcing elements is positioned radially between two working crown layers.

According to this embodiment of the invention, the layer of circumferential reinforcing elements makes it possible to limit the compressing of the reinforcing elements of the carcass reinforcement to a greater extent than a similar layer placed radially on the outside of the working layers. It is preferably radially separated from the carcass reinforcement by at least one working layer so as to limit the stress loadings on said reinforcing elements and avoid fatiguing them excessively.

Advantageously also according to the invention, the axial widths of the working crown layers radially adjacent to the layer of circumferential reinforcing elements are greater than the axial width of said layer of circumferential reinforcing elements and preferably said working crown layers adjacent to the layer of circumferential reinforcing elements are on either side of the equatorial plane and in the immediate axial continuation of the layer of circumferential reinforcing elements coupled over an axial width and then decoupled by a layer C of rubber compound at least over the remainder of the width that said two working layers have in common.

The presence of such couplings between the working crown layers adjacent to the layer of circumferential reinforcing elements allows a reduction in the tensile stresses acting on the axially outermost circumferential elements located closest to the coupling.

According to one advantageous embodiment of the invention, the reinforcing elements of at least one layer of circumferential reinforcing elements are metal reinforcing elements having a secant modulus at 0.7% elongation of between 10 and 120 GPa and a maximum tangent modulus of less than 150 GPa.

According to a preferred embodiment, the secant modulus of the reinforcing elements at 0.7% elongation is less than 100 GPa and greater than 20 GPa, preferably between 30 and 90 GPa and more preferably less than 80 GPa.

Also preferably, the maximum tangent modulus of the reinforcing elements is less than 130 GPa and more preferably less than 120 GPa.

The moduli expressed above are measured on a curve of tensile stress as a function of elongation determined with a preload of 20 MPa, corrected for the cross section of metal of the reinforcing element, the tensile stress corresponding to a measured tension corrected for the cross section of metal of the reinforcing element.

The moduli for the same reinforcing elements may be measured on a curve of tensile stress as a function of elongation determined with a preload of 10 MPa corrected for the overall cross section of the reinforcing element, the tensile stress corresponding to a measured tension corrected for the overall cross section of the reinforcing element. The overall cross section of the reinforcing element is the cross section of a composite element consisting of metal and of rubber, the latter having especially penetrated the reinforcing element during the phase of curing the tire.

According to this formulation relating to the overall cross section of the reinforcing element, the reinforcing elements of the axially outer parts and of the central part of at least one layer of circumferential reinforcing elements are metal reinforcing elements having a secant modulus at 0.7% elongation of between 5 and 60 GPa and a maximum tangent modulus of less than 75 GPa.

According to one preferred embodiment, the secant modulus of the reinforcing elements at 0.7% elongation is less than 50 GPa and greater than 10 GPa, preferably between 15 and 45 GPa, and more preferably less than 40 GPa.

Also preferably, the maximum tangent modulus of the reinforcing elements is less than 65 GPa and more preferably less than 60 GPa.

According to one preferred embodiment, the reinforcing elements of at least one layer of circumferential reinforcing elements are metal reinforcing elements that have a curve of tensile stress as a function of relative elongation that exhibits shallow gradients for small elongations and a gradient that is substantially constant and steep for greater elongations. Such reinforcing elements of the additional ply are normally known as “bimodulus” elements.

According to a preferred embodiment of the invention, the substantially constant and steep gradient appears upwards of a relative elongation of between 0.1% and 0.5%.

The various characteristics of the reinforcing elements mentioned above are measured on reinforcing elements taken from tires.

Reinforcing elements more particularly suited to the creation of at least one layer of circumferential reinforcing elements according to the invention are, for example, assemblies of formula 21.23, the construction of which is 3×(0.26+6×0.23) 4.4/6.6 SS; this stranded cord consists of 21 elementary threads of formula 3×(1+6), with 3 strands twisted together, each one consisting of 7 threads, one thread forming a central core of a diameter equal to 26/100 mm, and 6 wound threads of a diameter equal to 23/100 mm. Such a cord has a secant modulus at 0.7% equal to 45 GPa and a maximum tangent modulus equal to 98 GPa, these being measured on a curve of tensile stress as a function of elongation determined with a preload of 20 MPa corrected for the cross section of metal of the reinforcing element, the tensile stress corresponding to a measured tension corrected for the cross section of metal of the reinforcing element. On a curve of tensile stress as a function of elongation determined with a preload of 10 MPa corrected for the overall cross section of the reinforcing element, the tensile stress corresponding to a measured tension corrected for the overall cross section of the reinforcing element, this cord of formula 21.23 has a secant modulus at 0.7% equal to 23 GPa and a maximum tangent modulus equal to 49 GPa.

In the same way, another example of reinforcing elements is an assembly of formula 21.28, the construction of which is 3×(0.32+6×0.28) 6.2/9.3 SS. This cord has a secant modulus at 0.7% equal to 56 GPa and a maximum tangent modulus equal to 102 GPa, these measured on a curve of tensile stress as a function of elongation determined with a preload of 20 MPa corrected for the cross section of metal of the reinforcing element, the tensile stress corresponding to a measured tension corrected for the cross section of metal of the reinforcing element. On a curve of tensile stress as a function of elongation determined with a preload of 10 MPa corrected for the overall cross section of the reinforcing element, the tensile stress corresponding to a measured tension corrected for the overall cross section of the reinforcing element, this cord of formula 21.28 has a secant modulus at 0.7% equal to 27 GPa and a maximum tangent modulus equal to 49 GPa.

The use of such reinforcing elements in at least one layer of circumferential reinforcing elements especially makes it possible to maintain satisfactory stiffnesses of the layer even after the shaping and curing stages in conventional manufacturing methods.

According to a second embodiment of the invention, the circumferential reinforcing elements may be formed of metal elements that are inextensible and cut in such a way as to form portions of a length very much less than the circumference of the shortest layer, but preferentially greater than 0.1 times said circumference, the cuts between portions being axially offset from one another. Preferably again, the tensile elastic modulus per unit width of the additional layer is less than the tensile elastic modulus, measured under the same conditions, of the most extensible working crown layer. Such an embodiment makes it possible, in a simple way, to confer on the layer of circumferential reinforcing elements a modulus which can be easily adjusted (by the choice of the intervals between portions of one and the same row) but which in all cases is lower than the modulus of the layer consisting of the same metal elements but with the latter being continuous, the modulus of the additional layer being measured on a vulcanized layer of cut elements which has been removed from the tire.

According to a third embodiment of the invention, the circumferential reinforcing elements are wavy metal elements, the ratio a/λ of the wave amplitude to the wavelength being at most equal to 0.09. Preferably, the tensile elastic modulus per unit width of the additional layer is less than the tensile elastic modulus, measured under the same conditions, of the most extensible working crown layer.

According to a variant embodiment of the invention, the reinforcing elements of said at least two working crown layers are crossed from one layer to the other, making angles of between 10° and 45° with the circumferential direction.

More preferably, the reinforcing elements of said at least two working crown layers are inextensible.

One preferred embodiment of the invention also provides for the crown reinforcement to be supplemented radially on the outside by at least one additional layer, referred to as a protective layer, oriented relative to the circumferential direction at an angle of between 10° and 45° and in the same direction as the angle formed by the inextensible elements of the working layer which is radially adjacent to it.

Advantageously according to the invention, the reinforcing elements of said at least one protective layer are elastic.

The protective layer may have an axial width less than the axial width of the narrowest working layer. Said protective layer may also have an axial width which is greater than the axial width of the narrowest working layer, such that it covers the edges of the narrowest working layer.

Further alternative forms may also make provision for the crown reinforcement to be supplemented, between the carcass reinforcement and the radially inner working layer closest to said carcass reinforcement, by a triangulation layer made of inextensible steel metal reinforcing elements that form an angle of greater than 45° with the circumferential direction and in the same direction as that of the angle formed by the reinforcing elements of the layer that is radially closest to the carcass reinforcement. Advantageously, said triangulation layer is made up of two half-layers positioned axially on either side of the circumferential median plane.

Further details and advantageous features of the invention will become evident hereinafter from the description of an exemplary embodiment of the invention given with reference to the FIGURE, which depicts a meridian view of a diagram of a tire according to one embodiment of the invention.

For ease of understanding, the FIGURE is not drawn to scale.

The FIGURE shows only a half-view of a tire which extends symmetrically about the axis XX′, which represents the circumferential median plane, or equatorial plane, of the tire.

In the FIGURE, the tire 1, of size 295/80 R 22.5, comprises a radial carcass reinforcement 2 anchored in two beads, not shown in the FIGURE. The carcass reinforcement 2 is formed of a single layer of metal cords. It further comprises a tread 5.

In the FIGURE, the carcass reinforcement 2 is hooped in accordance with the invention by a crown reinforcement 4 formed radially, from the inside to the outside:
of a first working layer 41 formed of metal cords oriented at an angle equal to 26°,
of a layer of circumferential reinforcing elements 42, formed of 21×23 steel metal cords, of the “bimodulus” type,
of a second working layer 43 formed of metal cords oriented at an angle equal to 18° and crossed with the metal cords of the first working layer, the cords of each of the working layers being oriented on either side of the circumferential direction,
of a protective layer 44 formed of elastic 18.23 metal cords, in which the spacing at which the cords are distributed is equal to 2 5 mm, which are oriented at an angle equal to 18° on the same side as the cords of the second working layer.

The axial width L₄₁ of the first working layer 41 is equal to 214 mm.

The axial width L₄₂ of the layer of circumferential reinforcing elements 42 is equal to 154 mm.

The axial width L₄₃ of the second working layer 43 is equal to 194 mm.

The axial width L₄₄ of the protective layer 44 is equal to 162 mm.

The reinforcing elements of the two working layers are metal cords of formula 9.30 of UHT type, having a diameter equal to 1.23 mm. They are distributed in each of the working layers with a spacing P equal to 2.25 mm.

The threads constituting the metal cords have a mechanical breaking strength R equal to 3556 MPa and therefore satisfy the relationship R≥4180−2130×D.

In accordance with the invention, the tensile elastic modulus at 10% elongation of the calendering layers of the protective layer 43 is less than 8.5 MPa and the macrodispersion Z value is greater than 85.

The value of log(ρ), which expresses the electrical resistivity of the calendering layers of the protective layer 43, is greater than 8 ohm·cm.

The maximum value of tan(δ), denoted tan(δ)max, of the calendering layers of the working crown layers 42 and 43 is less than 0.080.

The cumulative weight of the working layers, of the protective layer and of the layer of circumferential reinforcing elements of the reference tire, comprising the weight of the metal cords and of the calendering compounds, amounts to 9.8 kg.

The tire I according to the invention is compared to a reference tire T1 of the same dimension which differs from the tire according to the invention by metal cords of the two working layers which are cords of formula 9.35 of SHT type, having a diameter equal to 1.35 mm. They are distributed in each of the working layers with a spacing equal to 2.5 mm.

The cumulative weight of the working layers, of the protective layer and of the triangulation layer of the reference tire T1, comprising the weight of the metal cords and the calendering compounds, amounts to 10.4 kg.

The reference tires T further differ from the tires I according to the invention by the calendering compounds of the working crown layers 41 and 43, especially their tensile elastic modulus at 10% elongation and the Z value.

The tire I according to the invention is further compared to a second tire T2 which differs from the tire according to the invention solely by the nature of the calenderings of the working layers, identical to those of the tire T1.

The various compounds used are listed below.

| | Com- | Com- | Com- | Com- |
|---|---|---|---|---|
| | pound R1 | pound R2 | pound 1 | pound 2 |
| NR | 100 | 100 | 100 | 100 |
| Black N347 | 52 | | 50 | |
| Black N326 | | 47 | | |
| Black N234 | | | | 40 |
| Antioxidant | 1 | 1.5 | 1 | 1 |
| (6PPD) | | | | |
| Stearic acid | 0.65 | 0.9 | 0.65 | 0.65 |
| Zinc oxide | 9.3 | 7.5 | 9.3 | 9.3 |
| Cobalt salt | 1.12 | 1.12 | 1.12 | 1.12 |
| (CoAcac) | | | | |
| Sulfur | 6.1 | 4.5 | 6.1 | 6.1 |
| Accelerator | 0.93 | 0.8 | 0.93 | 0.93 |
| DCBS | | | | |
| Retarder CTP | 0.25 | 0.15 | 0.25 | 0.25 |
| PVI | | | | |
| MA₁₀ (MPa) | 10.4 | 5.99 | 6.4 | 5.3 |
| tan(δ)ₘₐₓ | 0.130 | 0.099 | 0.069 | 0.060 |
| Resistivity | 4 | 6 | 9 | >10 |
| (logrho) | | | | |
| Z value | 77 | 80 | 92 | 89 |

The tires I according to the invention are produced with working crown layers, the calenderings of which consist of compounds chosen from the compounds 1 and 2.

Reference tires T1 and T2 are produced with working crown layers, the calenderings of which consist of the compound R1 or of the compound R2.

Tests were carried out with tires I according to the invention and with reference tires T1.

First endurance tests were carried out on a test machine that forced each of the tires to run in a straight line at a speed equal to the maximum speed rating prescribed for said tire (the speed index) under an initial load of 4000 kg gradually increased in order to reduce the duration of the test.

Other endurance tests were carried out on a test machine that cyclically imposed a transverse loading and a dynamic overload on the tires. The tests were carried out for the tires according to the invention under conditions identical to those applied to the reference tires T1.

The tests thus carried out showed that the distances covered during each of these tests are substantially identical for the tires according to the invention and the reference tires T1. It is thus apparent that the tires according to the invention exhibit performance which is substantially equivalent in terms of endurance to that of the reference tires T1 when running on bituminous surfaces.

Tests aimed at characterizing the breaking strength of a tire crown reinforcement subjected to shock loadings were also carried out. These tests consist in pressing cylindrical-shaped polars against the tread of the tire inflated to a recommended pressure. The values express the energy required to obtain breakage of the crown block. The values are expressed with reference to a base 100, corresponding to the value measured for the reference tire.

| | |
|---|---|
| T1 | 100 |
| Invention | 99 |

These results show that, despite lightening the tire by decreasing the mass of its crown reinforcement, the breaking energy during a shock loading on the surface of the tread is substantially equivalent.

Other tests corresponding to endurance tests were carried out by running with vehicles travelling on a running surface consisting of damaging stones that become trapped in the void regions of the tread pattern of the tire tread. The vehicles then move into a tank of saline solution in order to allow the corrosive liquid to propagate within the tire via the cracks formed due to the damage caused by the stones.

After sufficient running, the reinforcing elements of the working crown layers are analyzed. The measurements carried out correspond to corroded lengths of reinforcing elements and numbers of breakages of said reinforcing elements.

Identical measurements are carried out on the tires I produced according to the invention, after covering an identical distance to that covered by the tires T2 under the same conditions.

The results are expressed in the following table with reference to a base 100 fixed for the reference tires T2. One base 100 is fixed for corroded lengths of reinforcing elements and another base 100 for the count of breakages of reinforcing elements.

| | Tire T2 | Tire I |
|---|---|---|
| Corroded length | 100 | 80 |
| Number of breakages | 100 | 70 |

These tests show especially that the design of the tires according to the invention makes it possible to delay the corrosion of the elements of the working crown layers and is therefore favorable to performance in terms of the endurance of the tires, despite lightening the tire by decreasing the mass of its crown reinforcement.

These same tests were reproduced on tires in accordance with the invention in which the elastomer compounds constituting the calendering layers of the protective layer are identical to the compounds used for the calendering layers of the working crown layers.

As above, after sufficient running, the reinforcing elements of the working crown layers, but also the reinforcing elements of the protective layer, are analyzed. As above, the measurements carried out correspond to corroded lengths of reinforcing elements and numbers of breakages of said reinforcing elements.

| | Tire T2 | Tire I |
|---|---|---|
| Corroded length in the protective | 100 | 80 |
| layer | | |
| Number of breakages in the | 100 | 70 |
| protective layer | | |
| Corroded length in the working | 100 | 70 |
| layers | | |
| Number of breakages in the | 100 | 60 |
| working layers | | |

It emerges from these tests that the choice of using identical compounds for the protective layer and the working layers makes it possible to delay the corrosion of the reinforcing elements of the protective layer and further delay the corrosion of the reinforcing elements of the working crown layers.

Moreover, rolling resistance measurements were taken.

The results of the measurements are given in the following table; they are expressed in kg/t, a value of 100 being assigned to the reference tire.

| | |
|---|---|
| Reference | 100 |
| Invention | 98 |

1.-15. (canceled)

16. A tire for a vehicle of heavy duty type, having a radial carcass reinforcement comprising a crown reinforcement formed of at least two working crown layers each comprising metal reinforcing elements inserted between two calendering layers of elastomer compound comprising a reinforcing filler consisting of at least carbon black, the crown reinforcement being capped radially by a tread, said tread being connected to two beads via two sidewalls, the crown reinforcement comprising at least one layer of circumferential reinforcing elements, wherein the reinforcing elements of the working crown layers are metal cords having a diameter of less than 1.3 mm, wherein at least one thread of each metal cord of at least one working crown layer is of at least UHT grade, wherein the tensile elastic modulus at 10% elongation of at least the radially outermost calendering layer of at least the radially outermost working crown layer is less than 8.5 MPa and wherein at least said radially outermost calendering layer of at least the radially outermost working crown layer has a macrodispersion Z value of greater than 85.

17. The tire according to claim 16, wherein the maximum value of tan(δ), denoted tan(δ)max, of at least said radially outermost calendering layer of at least the radially outermost working crown layer is less than 0.080.

18. The tire according to claim 16, wherein at least said radially outermost calendering layer of at least the radially outermost working crown layer is an elastomer compound based on natural rubber or on synthetic polyisoprene with a predominance of cis-1,4-linkages and optionally on at least one other diene elastomer, the natural rubber or synthetic polyisoprene in the case of a blend being present at a predominant content relative to the content of the other diene elastomer(s) used and on a reinforcing filler consisting:
a) either of carbon black used at a content of between 20 and 80 phr,
b) or of a blend of carbon black and a white filler, in which the overall filler content is between 20 and 80 phr, and preferably between 40 and 60 phr, said white filler being of silica and/or alumina type, comprising SiOH and/or AlOH surface functions selected from the group consisting of precipitated or fumed silicas, aluminas or aluminosilicates, or else carbon blacks modified during or after synthesis, with a BET specific surface area of between 30 and 260 m²/g.

19. The tire according to claim 16, wherein the reinforcing elements of at least one working crown layer are cords comprising an internal layer of M internal thread(s) and an external layer of N external threads, the external layer being wound around the internal layer.

20. The tire according to claim 19, wherein M=1 and N=5 or 6, or M=2 and N=7, 8 or 9.

21. The tire according to claim 19, wherein the reinforcing elements of the working crown layers are cords comprising an internal layer of M internal thread(s) and an external layer of N external threads, the external layer being wound around the internal layer, with M=1 or 2 and N=5, 6, 7 or 8, at least one of the internal or external threads of each cord, exhibiting a mechanical breaking strength R expressed in MPa such that R≥4180−2130×D, D being the diameter of the thread expressed in mm.

22. The tire according to claim 19, wherein the reinforcing elements of said at least two working layers are cords comprising an internal layer of M internal thread(s) and an external layer of N external threads, the external layer being wound around the internal layer, with M=1 or 2 and N=5, 6, 7 or 8, at least one of the internal or external threads of each cord, exhibiting a mechanical breaking strength R expressed in MPa such that R≥4400−2000×D, D being the diameter of the thread expressed in mm.

23. The tire according to claim 16, wherein at least said radially outermost calendering layer of at least one protective layer has an electrical resistivity per unit volume ρ such that log(ρ) is greater than 8.

24. The tire according to claim 16, wherein the metal reinforcing elements of at least said protective layer are cords having a flow rate of less than 5 cm³/min in the “permeability” test.

25. The tire according to claim 16, wherein the layer of circumferential reinforcing elements is positioned radially between two working crown layers.

26. The tire according to claim 16, wherein the reinforcing elements of at least one layer of circumferential reinforcing elements are metal reinforcing elements having a secant modulus at 0.7% elongation of between 10 and 120 GPa and a maximum tangent modulus of less than 150 GPa.

27. The tire according to claim 16, wherein the reinforcing elements of said at least two working crown layers are crossed from one layer to the other, making angles of between 10° and 45° with the circumferential direction.

28. The tire according to claim 16, wherein the reinforcing elements of said at least two working crown layers are inextensible metal cords.

29. The tire according to claim 16, wherein the crown reinforcement is supplemented radially on the outside by at least one additional ply, referred to as a protective ply, of “elastic” reinforcing elements, oriented at an angle of between 10° and 45° relative to the circumferential direction and of the same direction as the angle formed by the inextensible elements of the working ply which is radially adjacent thereto.

30. The tire according to claim 16, wherein the crown reinforcement also comprises a triangulation layer formed of metal reinforcing elements forming angles of greater than 60° with the circumferential direction.
